(19) United States
(12) Patent Application Publication
(10) Pub. No.: US 2012/0103661 A1
(43) Pub. Date: May 3, 2012

(54) ELECTRICAL INSULATING SHEET AND METHOD FOR MANUFACTURING THE SAME

(76) Inventors: Haruhiko Narusawa, Osaka-shi (JP); Atsushi Nakajima, Ohtsu-shi (JP)

(21) Appl. No.: 13/381,180

(22) PCT Filed: Jul. 8, 2010
(86) PCT No.: PCT/JP2010/061610

§ 371 Date: Dec. 28, 2011

(30) Foreign Application Priority Data
Aug. 20, 2009 (JP) 2009-190814

(51) Int. Cl. H01B 17/00; B05D 5/00

(52) U.S. Cl. 174/137 R; 427/246

(57) ABSTRACT

The present invention aims to provide an electrical insulating sheet having excellent heat resistance, electrical insulating properties, impregnating property with resin and insulating oil, mechanical strength and dimensional stability which is demanded for rotating electric machines, stationary electric machines (such as a transformer) and electric wire cables. According to the present invention, there is provided an electrical insulating sheet which uses, as a support, a woven or nonwoven fabric comprising polyester fiber and/or polyphenylene sulfide fiber, characterized in that the voids among the fibers of the support are filled with a heat resistant resin having continuous pores.

### TECHNICAL FIELD OF THE INVENTION

The present invention relates to an electrical insulating sheet which has excellent heat resistance, electrical insulating properties, impregnating property with resin and insulating oil, mechanical strength and dimensional stability and which is used for rotating electric machines, stationary electric machines (such as a transformer) and electric wire cables.

### BACKGROUND ART

For an electrical insulating sheet used for rotating electric machines, stationary electric machines (such as a transformer) and electric wire cables, there are demanded heat resistance, electrical insulating properties, mechanical strength, dimensional stability, impregnating property with resin and insulating oil and resistance to chemicals depending upon the use. Due to this reason, film of polyester or polyimide or paper/nonwoven fabric of cellulose type or aramid type has been used as a material for such an electrical insulating sheet. Particularly in the heat resistant use, polyimide film and paper/nonwoven fabric of aramid type have been used. Although the polyimide film is excellent in electrical insulating properties, heat resistance, tensile strength and dimensional stability, it has no impregnating property with resin and insulating oil whereby there is a problem that its tear strength is insufficient. On the other hand, although paper/nonwoven fabric of aramid type has excellent heat resistance and tear strength, there is a problem that dimensional stability under moisture and electrical insulating properties by its sole use are insufficient.

In order to overcome the problems as such, the Patent Document 1 proposes a laminate constituted from an aramid nonwoven fabric sheet and a polyester resin. Although this laminate shows excellent elongation at break and tear load, there is a problem that its impregnating property with resin and insulating oil is insufficient due to the presence of a dense polyester resin layer.

The Patent Document 2 proposes a heat resistant film prepared by impregnating a solution of heat resistant resin having imide group into a base material comprising a polyester resin fiber nonwoven fabric so that the heat resistant resin is carried thereon followed by baking. Although this film has tensile strength and heat resistance in a level which can be practically used for flexible printed circuit board (FPC), etc., its dielectric breakdown voltage is only 280 volts whereby there is a problem that the electrical insulating properties are determinately insufficient.

On the other hand, the Patent Document 3 proposes a heat resistant nonwoven fabric prepared by adhering an imide resin to a fiber mat mainly comprising an aromatic polyamide fiber by means of wet coagulation. The imide resin exists in this nonwoven fabric in such a manner that it covers only the fiber surface of the fiber mat and it does not fill the voids among the fibers. Therefore, its mechanical strength and dimensional stability are insufficient whereby there is a problem that high electrical insulating properties cannot be achieved.

### PRIOR ART DOCUMENTS

### Patent Documents

Patent Document 1: Japanese Patent Application Laid-Open (JP-A) No. 2006-501091

Patent Document 2: Japanese Patent Application Laid-Open (JP-A) No. 229625/89

Patent Document 3: Japanese Patent Application Laid-Open (JP-A) No. 146861/86

### DISCLOSURE OF THE INVENTION

### Problem That the Invention is to Solve

The present invention has been created in view of the current status in the prior art as such and its object is to provide an electrical insulating sheet having excellent heat resistance, electrical insulating properties, impregnating property with resin and insulating oil, mechanical strength and dimensional stability, which are demanded for an electrical insulating sheet used for rotating electric machines, stationary electric machines (such as a transformer) and electric wire cables.

### Means for Solving the Problem

In order to achieve such an object, the present inventor has extensively investigated the preferred structure of an electrical insulating sheet and, as a result, they found that an electrical insulating sheet having the above excellent characteristics can be prepared by using, as a support, a woven or nonwoven fabric comprising a certain type of fiber and by filling the voids among the fibers of the support with a heat resistant resin having continuous pores whereupon the present invention has been accomplished.

Thus, in accordance with the present invention, there is provided an electrical insulating sheet which uses, as a support, a woven or nonwoven fabric comprising polyester fiber and/or polyphenylene sulfide fiber, characterized in that the voids among the fibers of the support are filled with a heat resistant resin having continuous pores.

According to the preferred embodiment of the electrical insulating sheet of the present invention, the heat resistant resin is a polyamide-imide resin having a glass transition temperature of not lower than 200° C.. wherein an average pore size of the continuous pores is 0.1 to 10 μm.

Also, in accordance with the present invention, there is provided a method for manufacturing the electrical insulating sheet, characterized in that, a heat resistant resin solution is prepared, then the heat resistant resin solution is impregnated into a woven or nonwoven fabric comprising polyester fiber and/or polyphenylene sulfide fiber so that the voids among the fibers of the woven or nonwoven fabric are filled with the heat resistant resin solution, a coagulating solution is contacted with the heat resistant resin solution in the woven or nonwoven fabric so that the solvent in the heat resistant resin solution is substituted with the coagulating solution whereupon continuous pores are formed in the heat resistant resin.

According to the preferred embodiment of the method for manufacturing the electrical insulating sheet of the present invention, the woven or nonwoven fabric is subjected to a hot-press treatment at 100 to 400° C.. after the continuous pores are formed.

### Advantages of the Invention

In the electrical insulating sheet of the present invention, a woven or nonwoven fabric comprising polyester fiber and/or polyphenylene sulfide fiber is used as a support and the voids among the fibers of the support are filled with a heat resistant resin having many continuous pores. Therefore, the electrical insulating sheet of the present invention is excellent not only in terms of heat resistance, electrical insulating properties and impregnating property with resin and insulating oil but also in terms of mechanical strength and dimensional stability.

### BRIEF DESCRIPTION OF THE DRAWINGS

FIG. 1 is a picture of the surface of an example of the electrical insulating sheet of the present invention under a scanning electron microscope.

FIG. 2 is a partial enlargement of the picture of FIG. 1.

FIG. 3 is a picture where the region of the heat resistant resin of the picture of FIG. 1 is cut and the resulting cross section is enlarged.

FIG. 4 is a picture of the sheet of Comparative Example 4 under a laser microscope.

### BEST MODE FOR CARRYING OUT THE INVENTION

Firstly, the electrical insulating sheet of the present invention will be illustrated.

The electrical insulating sheet of the present invention is characterized in that woven or nonwoven fabric comprising polyester fiber and/or polyphenylene sulfide fiber is used as a support and the voids among the fibers of the support are filled with a heat resistant resin having continuous pores.

In order to ensure the mechanical strength and the dimensional stability, the support used for the electrical insulating sheet of the present invention is a woven or nonwoven fabric.

When the support is a woven fabric, any of monofilament yarn, multifilament yarn and staple yarn may be used as the yarn which constitutes the woven fabric. In view of the mechanical characteristic of the electrical insulating sheet, tensile strength of the yarn is preferred to be not less than 2.0 cN/dtex. With regard to the weaving constitution, there is no particular designation for its weaving configuration, yarn count and yarn density.

When the support is a nonwoven fabric, various methods such as wet paper manufacturing method, water punch method, chemical bond method, thermal bond method, spun bond method, needle punch method and stitch bond method may be used as a method for manufacturing the nonwoven fabric. In view of heat resistance, mechanical characteristic and resistance to solvents, preferred ones are spun bond method and thermal bond method using a self-melting fiber.

Basis weight of the woven or nonwoven fabric is preferred to be 5 to 500 g/m² and thickness thereof is preferred to be 0.01 to 7.5 mm. When the basis weight and the thickness are less than the above lower limits, there is a risk of poor mechanical strength while, when they are more than the above upper limits, there is a risk of insufficient flexibility of the electrical insulating sheet. Void volume of the woven or nonwoven fabric is preferred to be 40 to 95%. When the void volume is less than the above lower limit, there is a risk that the voids among the fibers are not well filled with the heat resistant resin whereby a poor heat resistance is resulted while, when it is more than the above upper limit, there is a risk that the fiber content of the electrical insulating sheet is insufficient whereby a poor mechanical strength is resulted.

Polyester fiber, polyphenylene sulfide fiber or a mixture thereof is used as a material for the support. That is because the fiber as such is in low cost and, in spite of that, it has excellent mechanical strength, heat resistance, electrical insulating properties and resistance to solvents.

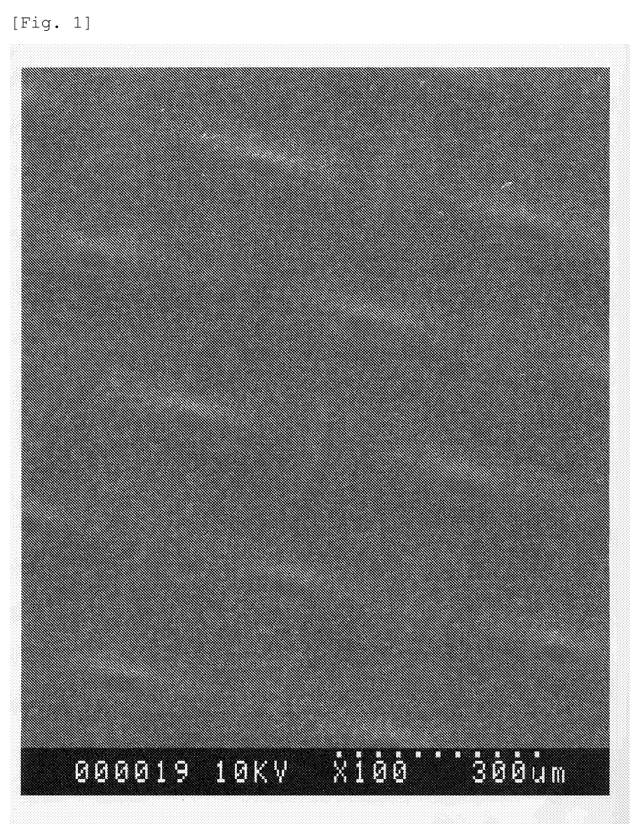

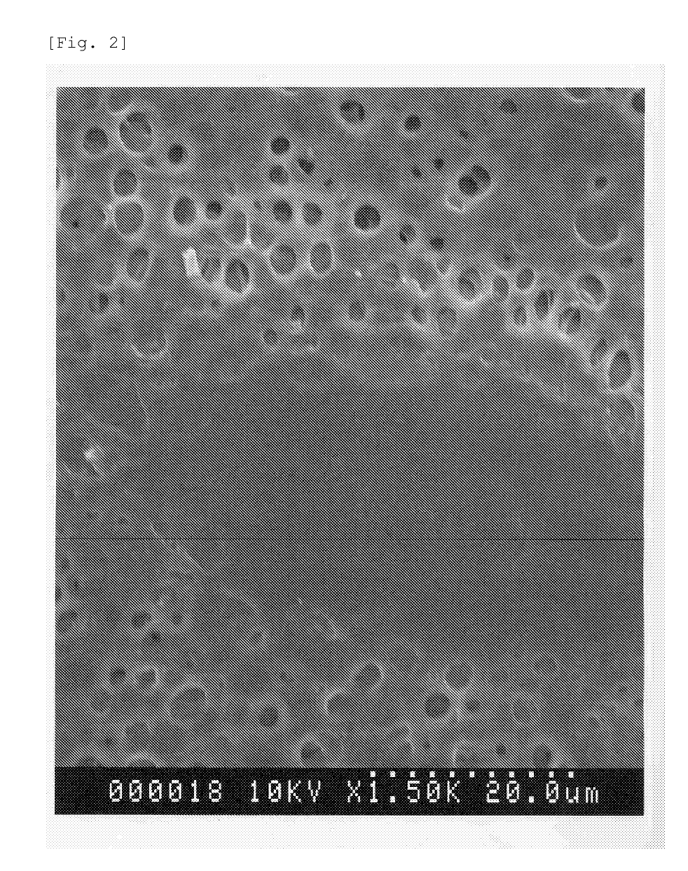

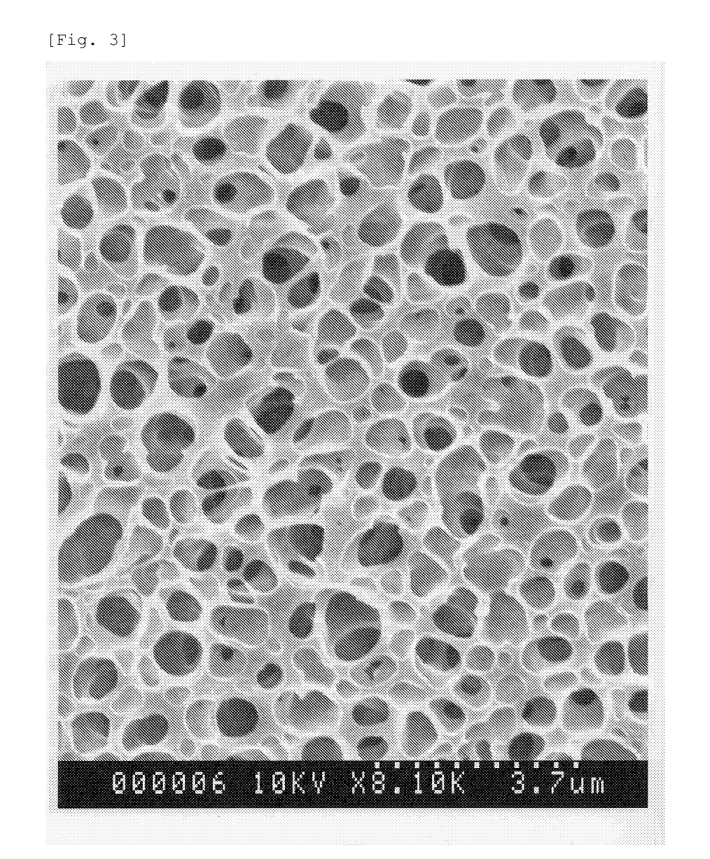

The biggest characteristic feature of the electrical insulating sheet of the present invention is that the voids among the fibers of the above support are filled with the heat resistant resin having continuous pores. Such a characteristic feature of the present invention is specifically shown by FIGS. 1 to 3. FIG. 1 is a picture of the surface of the electrical insulating sheet of the present invention under a scanning electron microscope. Small black parts in a nearly elliptic shape which are interspersed in FIG. 1 show the fiber in the support and other porous parts show the heat resistant resin. Many very small round-shaped ones in the figure are pores of the heat resistant resin. FIG. 2 is a partial enlargement of the picture of FIG. 1. In FIG. 2, fiber (black ones in a nearly elliptic shape) of the support is located almost in the center and, porous heat resistant resin is surrounding the fiber. FIG. 3 is a picture where the region of the heat resistant resin of the picture of FIG. 1 is cut and the resulting cross section is enlarged. State of the continuous pores in the heat resistant resin will be well understood from FIG. 3. As will be understood from FIGS. 1 and 2, the heat resistant resin not only covers the fiber surface of the support but also fills the voids among the fibers of the support in the electrical insulating sheet of the present invention. As will be further understood from FIG. 3, many fine continuous pores are formed in the heat resistant resin. Although the term reading continuous pores means such a thing where the pores are connected with each other so as to have a link, it is not always necessary that all pores are connected with each other but the cases where the pores are partially connected with each other may be covered thereby as well. The continuous pores as such have a role of enhancing the heat resistance, electrical insulating properties and impregnating property with resin and insulating oil to a level which has not been achieved in the past.

Average pore size of the continuous pores in the heat resistant resin is preferred to be 0.05 to 20 μm and more preferred to be 0.1 to 10 μm. When the average pore size of the continuous pores is less the above lower limit, there is a risk that the impregnating property with resin and insulating oil becomes insufficient while, when it is more than the above upper limit, there is a risk of insufficient electrical insulating properties. Although the maximum pore size of the continuous pores is not particularly limited, it is preferred to be not more than 30 μm and more preferred to be not more than 20 μm in view of electrical insulating properties. Although the density of the continuous pores is not particularly limited, it is preferred to be 5,000 to 2,000,000 pores/mm² and more preferred to be 10,000 to 1,000,000 pores/mm². Control of the pore size and the density of the continuous pores can be easily conducted by adjusting the manufacturing conditions as will be mentioned later.

The content of the heat resistant resin in the electrical insulating sheet is preferred to be 20 to 80% by weight. When the content of the heat resistant resin is less than the above lower limit, there is a risk of poor heat resistance while, when it is more than the above upper limit, there is a risk that the fiber content of the electrical insulating sheet becomes insufficient whereby poor mechanical strength is resulted.

As to the heat resistant resin used in the electrical insulating sheet of the present invention, anything may be used so far as it is a synthetic resin having a glass transition temperature of not lower than 200° C. Examples thereof include polysulfone type polymer such as polysulfone or polyether sulfone; amide type polymer such as aromatic polyamide or alicyclic polyamide; and imide type polymer such as polyamide-imide resin and polyether-imide resin. Among them, polyamide-imide resin is particularly preferred because of its excellent electric characteristic and electrical insulating properties.

Polyamide-imide resin can be produced by a conventionally known method and, for example, it can be easily produced in such a manner that a material monomer is stirred while heating at 60 to 200° C. for polymerization in an amide type solvent such as N,N-dimethylacetamide, N,N-dimethylformamide or N-methyl-2-pyrrolidone or in a sulfoxide type solvent such as dimethyl sulfoxide. Molecular weight of the polyamide-imide resin is preferred to be not less than 0.4 dl/g and more preferred to be not less than 0.5 dl/g and most preferred to be not less than 0.7 dl/g in terms of logarithmic viscosity. When the logarithmic viscosity is less than the above lower limit, there is a risk that the polyamide-imide resin becomes brittle and its heat resistance and mechanical strength lower. Although there is no particular limitation for the upper limit of the logarithmic viscosity, it is preferred to be not more than 2.0 dl/g in view of the fluidity upon making the resin into a solution.

Now the method for manufacturing the electrical insulating sheet according to the present invention will be illustrated.

Firstly, a heat resistant resin solution is prepared. With regard to a solvent for the solution, preferred one is that which can dissolve the heat resistant resin to an extent of not less than 5% by weight and can easily mix with a coagulating solution which will be mentioned later. For example, when the heat resistant resin is polyamide-imide, there may be used an amide type solvent such as N,N-dimethylacetamide, N,N-dimethylformamide or N-methyl-2-pyrrolidone or a sulfoxide type solvent such as dimethyl sulfoxide as a solvent. Since the solvents as such are the same as those which can be used for polymerization of the above polyamide-imide resin, it is also possible that the polyamide-imide resin is polymerized in such a solvent and then the resulting solution (a solution where the polymerized polyamide-imide resin is dissolved in the polymerization solvent) is used just as it is as the heat resistant resin solution.

Concentration of the heat resistant resin in the solution is preferred to be 5 to 40% by weight. When the concentration of the heat resistant resin is less than the above lower limit, there is a risk that the impregnating amount of the heat resistant resin into the support is insufficient resulting in poor heat resistance while, when it is more than the above upper limit, there is a risk that fluidity of the solution lowers, which causes the difficulty in impregnation into the support.

In order to adjust the coagulating speed when the solvent is eluted into a coagulating solution, it is also possible to add an alcohol such as methanol, ethanol, propyl alcohol, ethylene glycol, diethylene glycol, polyethylene glycol or polypropylene glycol or a ketone such as acetone or methyl ethyl ketone to the heat resistant resin solution. Adding amount of the alcohol or ketone as such is preferred to be 0 to 40% by weight in terms of the concentration in the solution.

After that, the heat resistant resin solution prepared as such is impregnated into the woven or nonwoven fabric to be used as a support so that the voids among the fibers in the woven or nonwoven fabric are filled with the heat resistant resin solution. There is no particular limitation for an impregnating method but any of well-known methods such as bar coating method, roll coating method and dip coating method may be adopted. After the impregnation, an excessive resin solution is removed by, for example, passing through mangle rolls if necessary.

After that, a coagulating solution is contacted with the heat resistant resin solution in the woven or nonwoven fabric. As to the coagulating solution, it is preferred to use water or a solution mainly comprising water (such as a mixture of water with the heat resistant resin solution). There is no limitation for a method of contacting the coagulating solution but there may be used a method where the woven or nonwoven fabric impregnated with the heat resistant resin solution is dipped in the coagulation solution, and a method where the coagulating solution is sprayed onto the woven or nonwoven fabric impregnated with the heat resistant resin solution, etc. When the coagulating solution contacts with the heat resistant resin solution filled in the voids among the fibers of woven or nonwoven fabric, the solvent in the heat resistant resin solution is substituted with the coagulating solution and the solvent is eluted to the coagulating solution whereupon the heat resistant resin is subjected to a phase separation from the solution to coagulate in a porous form whereupon the continuous pores are formed in the heat resistant resin. By adjusting temperature of the coagulating solution, component of coagulating solution additive (such as the solvent for the above heat resistant resin) or concentration of the coagulating solution additive at that time, pore size and density of the resulting continuous pores can be controlled. After that, washing with water is conducted if necessary followed by drying to remove the moisture therefrom.

Although the electrical insulating sheet manufactured as above may be used just as it is, it is preferred to subject the sheet to a hot-press treatment at 100 to 400° C. so as to further enhance the electrical insulating properties and mechanical strength per thickness. There is no particular limitation for the hot-press treatment method and, for example, a well-known press method such as a method using a flat plate press or a method using a calender roll may be adopted. If necessary, temperature of the sheet may be raised using a preheater prior to the hot-press treatment. Temperature for the hot-press treatment is 100 to 400° C., preferably 120 to 300° C. and more preferably 150 to 300° C. When the temperature for the hot-press treatment is lower than the above lower limit, there is a risk that the heat resistant resin is still in a hard state and the effect by the hot-press treatment is not achieved while, when it is higher than the above upper limit, there is a risk that not only the sheet surface becomes coarse and fluffs increase but also the continuous pores on the sheet surface are clogged and impregnating property with resin and insulating oil is deteriorated. Linear pressure for the hot-press treatment is preferred to be 10 to 500 kg/cm. When the linear pressure is less than the above lower limit, there is a risk that the effect of press is insufficient while, when it is more than the above upper limit, there is a risk that the continuous pores on the sheet surface are clogged and the impregnating property with resin and insulating oil is deteriorated.

The electrical insulating sheet of the present invention manufactured as mentioned above shows a breaking load of not less than 10 N/15 mm, a tear load of not less than 0.5 N, a dielectric breakdown voltage of not less than 1 kV, an air permeability of 100 to 50,000 second/100 ml and a elongation at break of not less than 6% and has excellent heat resistance, electrical insulating properties, impregnating property with resin and insulating oil, mechanical strength and dimensional stability which are sufficient for using in rotating electric machines, stationary electric machines (such as transformer) and electric wire cables.

### EXAMPLES

The present invention will now be illustrated in more detail as hereunder by Examples although the present invention is not limited to these Examples. “Part” in the Examples means “part by weight”. Measurement values in the Examples were measured in accordance with the following methods.

1. Logarithmic Viscosity

A solution prepared by dissolving 0.5 g of polyamide-imide resin in 100 ml of NMP (N-methyl-2-pyrrolidone) was used and logarithmic viscosity of the solution was measured at 25° C. using an Ubbelohde's viscometer.

2. Glass Transition Temperature

A polyamide-imide resin solution was applied onto a polyester film support having 100 μm thickness so as to make the film thickness about 30 μm, and dried at 100° C. for 10 minutes. Then, the film was detached from the polyester film support, fixed to a metal frame and further dried at 250° C. for 1 hour. The resulting film was used for the measurement of loss elastic modulus under the condition of temperature-raising speed of 5° C./minute and frequency of 110 Hz using a measuring device for dynamic viscosity manufactured by IT Keisoku Seigyo KK, and an inflection point thereof was adopted as a glass transition temperature.

3. Basis Weight (Mass Per Unit Area)

Three test pieces of 20 cm×20 cm each were collected from the resulting sheet using a razor blade. Mass per unit area of each test piece was measured according to a method mentioned in JIS L1096 and a mean value of the three test pieces was calculated.

4. Thickness

Thickness was measured according to a method mentioned in JIS C2111 using a thickness gauge manufactured by Mitutoyo Corporation.

5. Pore Size and Pore Density

Picture under a scanning electron microscope (SEM) of the cross section of the resulting sheet was taken in 1,000 to 10,000 magnifications depending upon the pore size and the pore density. The pore sizes of all pores observed in the foreground of the picture were measured and the average pore size and the maximum pore size were determined. When the pore is not nearly circular, the value obtained by adding the long diameter to the short diameter followed by dividing by 2 was adopted as the size of the pore. Further, numbers of the pores in the taken area of the picture were counted and the pore numbers was divided by the taken area (mm²) so as to calculate the pore density.

6. Breaking Load and Elongation at Break

A test piece of 15 mm width and 150 mm length was prepared by cutting the resulting sheet using a razor blade. Breaking load and elongation at break of the test piece were determined according to JIS C2111 (in case of the measurement where the test piece is not bent) under the condition of test speed of 200 mm/min and under the atmosphere of 23° C. and 50% RH using a Tensilon All-Purpose Tester manufactured by Orientec Co., LTD.

7. Tear Load

A test piece of 50 mm width and 150 mm length was prepared by cutting the resulting sheet using a razor blade and a cut of 75 mm length was made in the center of the test piece. Tear load of the teat piece was determined according to Al method mentioned in JIS L1096 under the condition of test speed of 200 mm/min and under the atmosphere of 23° C. and 50% RH using a Tensilon All-Purpose Tester manufactured by Orientec Co., LTD.

8. Dielectric Breakdown Voltage

Dielectric breakdown voltage was measured using an insulation resistance tester (manufactured by Kikusui Electronics Corporation) according to a method mentioned in ASTM D149. To be more specific, the breakdown voltage when voltage of 60 Hz was applied at the speed of 0.1 kV/second in the thickness direction of a test piece was read. The dielectric breakdown voltage per thickness was determined from the read breakdown voltage.

9. Air Permeability

A test piece of 50 mm square was cut out from the resulting sheet and its air permeability was determined according to a Gurley method mentioned in JIS P8117 using a Gurley-type densometer (manufactured by Tester Sangyo Co., LTD.).

(Synthesis of Heat Resistant Resins)

As the heat resistant resins, two types of polyamide-imide resins A and B were synthesized as follows.

(Synthesis of Polyamide-imide Resin A)

Into a four-necked flask equipped with thermometer, cooling pipe and nitrogen gas-introducing pipe were charged 0.98 mol of trimellitic anhydride (TMA), 1 mol of diphenylmethane 4,4′-diisocyanate (MDI) and 0.01 mol of diazabicycloundecene (DBU) as material monomers together with N-methyl-2-pyrrolidone (NMP) as a solvent so as to make the solid concentration 20% and then the reaction was conducted for about 3 hours by raising the temperature up to 120° C. together with stirring to give polyamide-imide resin A. The polyamide-imide resin A was obtained in a state of solution being dissolved in NMP. Logarithmic viscosity of the resulting polyamide-imide resin A was 0.90 dl/g and glass transition temperature thereof was 280° C.

(Synthesis of Polyamide-imide Resin B)

Into the same device as in the synthesis of polyamide-imide resin A were charged 0.99 mol of TMA, 0.8 mol of MDI, 0.2 mol of 2,4-tolylene diisocyanate (TDI) and 0.01 mol of diazabicycloundecene (DBU) as material monomers together with NMP as a solvent so as to make the solid concentration 20% and then the reaction was conducted for about 2 hours at 120° C. together with stirring to give polyamide-imide resin B. The polyamide-imide resin B was obtained in a state of solution being dissolved in NMP. Logarithmic viscosity of the resulting polyamide-imide resin B was 0.75 dl/g and glass transition temperature thereof was 300° C.

### Example 1

A solution (100 parts) of the polyamide-imide resin A prepared as above was mixed with 20 parts of ethylene glycol, the resulting solution was impregnated into a woven fabric of polyester (a woven fabric for mesh filters manufactured by Nippon Tokushu fabric Co., Ltd.; basis weight: 30 g/m²; thickness: 0.095 mm; yarn diameter: 55 μm) as a support so that voids among the fibers of the woven fabric were filled with the polyamide-imide resin A solution followed by passing through mangle rolls to remove an excessive resin solution. After that, the above was dipped into a coagulating bath of water/N-methyl-2-pyrrolidone (in 70/30 ratio by weight) kept at 20° C. to coagulate the polyamide-imide resin A followed by dipping into an ion-exchange water for 1 hour for washing. After the ion-exchange water was wiped off, the above was stored in a hot-air kept at 100° C. for 10 minutes to remove water whereupon an electrical insulating sheet was prepared. When the structure of the resulting electrical insulating sheet was confirmed under a scanning electron microscope, the voids among the fibers of the woven fabric were filled with the polyamide-imide resin A having continuous pores as shown in FIGS. 1 to 3. Characteristic properties of the resulting electrical insulating sheet are shown in Table 1.

### Example 2

The same operation as in Example 1 was carried out except that a polyester woven fabric (basal fabric for adhesive core manufacture by Tohkai Thermo Co., LTD.; basis weight: 32 g/m²; thickness: 0.160 mm) was used as a support whereupon an electrical insulating sheet was prepared. When the structure of the resulting electrical insulating sheet was confirmed under a scanning electron microscope, the voids among the fibers of the woven fabric were filled with the polyamide-imide resin A having continuous pores as in Example 1. Characteristic properties of the resulting electrical insulating sheet are shown in Table 1.

### Example 3

The same operation as in Example 2 was carried out except that a solution of the polyamide-imide resin B was used instead of a solution of the polyamide-imide resin A whereupon an electrical insulating sheet was prepared. When the structure of the resulting electrical insulating sheet was confirmed under a scanning electron microscope, the voids among the fibers of the woven fabric were filled with the polyamide-imide resin B having continuous pores as in Example 1. Characteristic properties of the resulting electrical insulating sheet are shown in Table 1.

### Example 4

The same operation as in Example 3 was carried out except that a polyester nonwoven fabric (polyester spun bonded nonwoven fabric manufactured by Toyobo Co., LTD.; basis weight: 30 g/m²; thickness: 0.125 mm) was used as a support whereupon an electrical insulating sheet was prepared. When the structure of the resulting electrical insulating sheet was confirmed under a scanning electron microscope, the voids among the fibers of the nonwoven fabric were filled with the polyamide-imide resin B having continuous pores as in Example 1. Characteristic properties of the resulting electrical insulating sheet are shown in Table 1.

### Example 5

The same operation as in Example 4 was carried out except that a polyphenylene sulfide nonwoven fabric (polyphenylene sulfide spun bonded nonwoven fabric manufactured by Toyobo Co., LTD.; basis weight: 34 g/m²; thickness: 0.140 mm) was used as a support whereupon an electrical insulating sheet was prepared. When the structure of the resulting electrical insulating sheet was confirmed under a scanning electron microscope, the voids among the fibers of the nonwoven fabric were filled with the polyamide-imide resin B having continuous pores as in Example 1. Characteristic properties of the resulting electrical insulating sheet are shown in Table 1.

### Example 6

The electrical insulating sheet prepared in Example 3 was subjected to a treatment at the linear pressure of 100 kg/cm and a running speed of 5 m/minute using a calender roll of 20 cm diameter the temperature of which was raised up to 200° C. previously to give an electrical insulating sheet subjected to a hot-press treatment. Characteristic properties of the resulting electrical insulating sheet are shown in Table 1.

### Example 7

The electrical insulating sheet prepared in Example 4 was subjected to a treatment at the linear pressure of 100 kg/cm and a running speed of 5 m/minute using a calender roll of 20 cm diameter the temperature of which was raised up to 240° C. previously to give an electrical insulating sheet subjected to a hot-press treatment. Characteristic properties of the resulting electrical insulating sheet are shown in Table 1.

### Comparative Example 1

A solution (100 parts) of the polyamide-imide resin A was mixed with 20 parts of ethylene glycol and the resulting solution was applied onto a polyester film (E-5100 manufactured by Toyobo) using an applicator so as to make the membrane thickness about 60 μm. After that, the above was dipped into a coagulating bath of water/N-methyl-2-pyrrolidone (in 70/30 ratio by weight) kept at 20° C. to coagulate the polyamide-imide resin A followed by dipping into an ion-exchange water for 1 hour for washing. After the ion-exchange water was wiped off, the above was stored in a hot-air kept at 100° C. for 30 minutes to remove water. After that, the polyester film was detached to give an electrical insulating sheet solely consisting of the polyamide-imide resin A. Characteristic properties of the resulting electrical insulating sheet are shown in Table 1.

### Comparative Example 2

The same operation as in Comparative Example 1 was carried out except that a solution of the polyamide-imide resin B was used instead of a solution of the polyamide-imide resin A whereupon an electrical insulating sheet solely consisting of the polyamide-imide resin B was prepared. Characteristic properties of the resulting electrical insulating sheet are shown in Table 1.

### Comparative Example 3

A polyester nonwoven fabric (spun bonded nonwoven fabric manufactured by Toyobo Co., LTD.; basis weight: 45 g/m²; thickness: 0.175 mm) was subjected to a treatment at the linear pressure of 100 kg/cm and a running speed of 5 m/minute using a calender roll of 20 cm diameter the temperature of which was raised up to 200° C. previously to give a sheet subjected to a hot-press treatment. Characteristic properties of the resulting sheet are shown in Table 1.

### Comparative Example 4

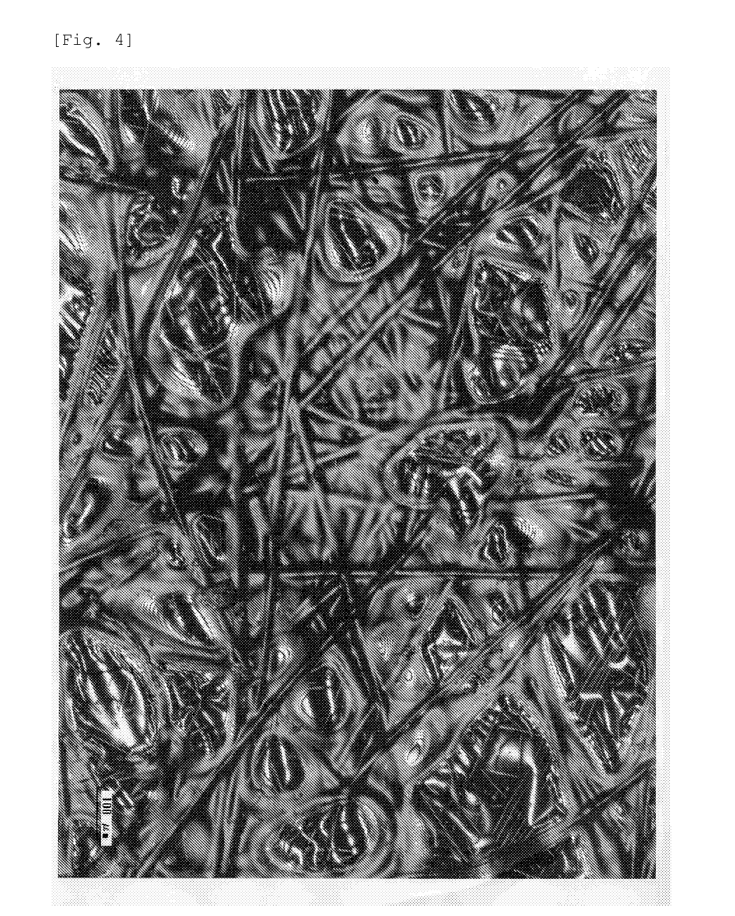

A solution of polyamide-imide resin B was impregnated into a polyester nonwoven fabric (polyester spun bonded nonwoven fabric manufactured by Toyobo Co., LTD.; basis weight: 30 g/m²; thickness: 0.125 mm) and then passed through mangle rolls to remove an excessive resin solution. After that, the fabric was fixed to a metal frame, subjected to a preliminary drying for 10 minutes using a hot-air drier kept at 100° C. and further subjected to a drying for 5 minutes using a hot-air drier kept at 200° C. so that the heat resistant resin was baked to give a sheet. The structure of the resulting sheet was confirmed under a laser microscope (manufactured by Keyence Corporation) in 200 magnifications whereupon, as shown in FIG. 4, there were many pores in a pore size of 50 to 100 μm. It is likely that those pores have been produced by evaporation of the heat resistant resin solution to dryness in the voids among the fibers of the nonwoven fabric. Further, it is likely that those pores were individually open pores and were not continuous pores. Characteristic properties of the resulting sheet are shown in Table 1.

TABLE 1
Characteristic properties of the sheets prepared in Examples and Comparative Examples

| | | | | | | | Dielectric | |
|---|---|---|---|---|---|---|---|---|
| | | | | Basis | | | breakdown | Air |
| | Heat resistant | | Hot-press | weight | | Thickness | voltage | Permeability |
| | resin | Support | treatment | (g/m²) | | (mm) | (kV) | (s/100 ml) |
| Example 1 | polyamide- | polyester woven fabric | absent | 57 | | 0.103 | 2.12 | 1,041 |
| | imide resin A | | | | | | | |
| Example 2 | polyamide- | polyester woven fabric | absent | 67 | | 0.171 | 1.85 | 797 |
| | imide resin A | | | | | | | |
| Example 3 | polyamide- | polyester woven fabric | absent | 69 | | 0.164 | 1.96 | 608 |
| | imide resin B | | | | | | | |
| Example 4 | polyamide- | polyester nonwoven | absent | 62 | | 0.135 | 1.42 | 315 |
| | imide resin B | fabric | | | | | | |
| Example 5 | polyamide- | polyphenylene sulfide | absent | 66 | | 0.148 | 1.14 | 441 |
| | imide resin B | nonwoven fabric | | | | | | |
| Example 6 | polyamide- | polyester woven fabric | present | 69 | | 0.064 | 1.51 | 24,260 |
| | imide resin B | | | | | | | |
| Example 7 | polyamide- | polyester nonwoven | present | 62 | | 0.066 | 1.29 | 14,165 |
| | imide resin B | fabric | | | | | | |
| Comparative | polyamide- | absent | absent | 19 | | 0.051 | 2.65 | 1,326 |
| Example 1 | imide resin A | | | | | | | |
| Comparative | polyamide- | absent | absent | 19 | | 0.055 | 2.70 | 1,317 |
| Example 2 | imide resin B | | | | | | | |
| Comparative | absent | polyester nonwovem | present | 45 | | 0.052 | 0.53 | 1 |
| Example 3 | | fabric | | | | | | |
| Comparative | polyamide- | polyester nonwoven | absent | 71 | | 0.149 | 0.72 | 11 |
| Example 4 | imide resin B | fabric | | | | | | |
| | Average | Maximum | Pore density | | | | | |
| | pore size | pore size | of the | | | | | |
| | of the | of the | continuous | | | Breaking | Elongation | |
| | continuous | continuous | pores | | | load | at break | Tear load |
| | pores (μm) | pores (μm) | (pores/mm²) | Direction | | (N/15 mm) | (%) | (N) |
| Example 1 | 0.9 | 1.6 | 570,000 | MD | (longitudinal) | 115 | 22 | 4.2 |
| | | | | CD | (lateral) | 117 | 22 | 4.1 |
| Example 2 | 1.2 | 1.9 | 89,000 | MD | (longitudinal) | 81 | 21 | 4.5 |
| | | | | CD | (lateral) | 72 | 15 | 3.7 |
| Example 3 | 3.0 | 4.3 | 79,000 | MD | (longitudinal) | 85 | 23 | 5.0 |
| | | | | CD | (lateral) | 75 | 16 | 3.9 |
| Example 4 | 2.9 | 4.0 | 51,000 | MD | (longitudinal) | 66 | 22 | 3.0 |
| | | | | CD | (lateral) | 40 | 16 | 3.4 |
| Example 5 | 2.8 | 5.2 | 86,000 | MD | (longitudinal) | 39 | 20 | 2.8 |
| | | | | CD | (lateral) | 24 | 15 | 3.0 |
| Example 6 | — | — | — | MD | (longitudinal) | 71 | 21 | 3.0 |
| | | | | CD | (lateral) | 63 | 14 | 2.3 |
| Example 7 | — | — | — | MD | (longitudinal) | 54 | 9 | 1.0 |
| | | | | CD | (lateral) | 44 | 7 | 1.4 |
| Comparative | 0.7 | 1.2 | 440,000 | MD | (longitudinal) | 16 | 41 | 0.05 |
| Example 1 | | | | CD | (lateral) | 16 | 38 | 0.05 |
| Comparative | 0.7 | 1.3 | 550,000 | MD | (longitudinal) | 17 | 42 | 0.05 |
| Example 2 | | | | CD | (lateral) | 16 | 45 | 0.05 |
| Comparative | — | — | — | MD | (longitudinal) | 85 | 22 | 7.5 |
| Example 3 | | | | CD | (lateral) | 21 | 14 | 10.1 |
| Comparative | — | — | — | MD | (longitudinal) | 67 | 11 | 1.1 |
| Example 4 | | | | CD | (lateral) | 49 | 6 | 2.0 |

(Note)
Although the measurement of average pore size, maximum pore size and pore density of the continuous pores in Examples 6 and 7 were difficult since the pores were crushed due to hot-press treatment, it is likely that their average pore size, maximum pore size and pore density correspond to those which are obtained by crushing the pores of Examples 3 and 4.

As will be understood from Table 1, the electrical insulating sheets of Examples 1 to 7 had high dielectric breakdown voltage, air permeability, breaking load, elongation at break and tear load and were excellent in electrical insulating properties, impregnating property with resin and insulating oil, mechanical strength and dimensional stability. On the contrary, in the electrical insulating sheets of Comparative Examples 1 and 2 where no support was used, although the elongation at break was high, their breaking load and tear strength were low whereby the mechanical strength and the dimensional stability were inferior. Further, in the sheet of Comparative Example 3 where no heat resistant resin was used, its dielectric breakdown voltage and air permeability were low whereby the electrical insulating properties were inferior. Furthermore, in the sheet of Comparative Example 4 where the heat resistant resin was baked instead of wet membrane formation, there were large pores on the sheet and, therefore, its dielectric breakdown voltage and air permeability were low whereby its electrical insulating properties were inferior in spite of the fact that the heat resistant resin was used.

### INDUSTRIAL APPLICABILITY

Since the electrical insulating sheet of the present invention is very well-balanced in its heat resistance, electrical insulating properties, impregnating property with resin and insulating oil, mechanical strength and dimensional stability, it is quite useful as a material to be used for rotating electric machines, stationary electric machines (such as a transformer) and electric wire cables.

1. An electrical insulating sheet which uses, as a support, a woven or nonwoven fabric comprising polyester fiber and/or polyphenylene sulfide fiber, characterized in that the voids among the fibers of the support are filled with a heat resistant resin having continuous pores.

2. The electrical insulating sheet according to claim 1, wherein the heat resistant resin is a polyamide-imide resin having a glass transition temperature of not lower than 200° C.

3. The electrical insulating sheet according to claim 1, wherein an average pore size of the continuous pores is 0.1 to 10 μm.

4. A method for manufacturing the electrical insulating sheet defined in claim 1, characterized in that, a heat resistant resin solution is prepared, then the heat resistant resin solution is impregnated into a woven or nonwoven fabric comprising polyester fiber and/or polyphenylene sulfide fiber so that the voids among the fibers of the woven or nonwoven fabric are filled with the heat resistant resin solution, a coagulating solution is contacted with the heat resistant resin solution in the woven or nonwoven fabric so that the solvent in the heat resistant resin solution is substituted with the coagulating solution whereupon continuous pores are formed in the heat resistant resin.

5. The method for manufacturing the electrical insulating sheet according to claim 4, wherein the woven or nonwoven fabric is subjected to a hot-press treatment at 100 to 400° C. after the continuous pores are formed.

6. The electrical insulating sheet according to claim 2, wherein an average pore size of the continuous pores is 0.1 to 10 μm.

7. A method for manufacturing the electrical insulating sheet defined in claim 2, characterized in that, a heat resistant resin solution is prepared, then the heat resistant resin solution is impregnated into a woven or nonwoven fabric comprising polyester fiber and/or polyphenylene sulfide fiber so that the voids among the fibers of the woven or nonwoven fabric are filled with the heat resistant resin solution, a coagulating solution is contacted with the heat resistant resin solution in the woven or nonwoven fabric so that the solvent in the heat resistant resin solution is substituted with the coagulating solution whereupon continuous pores are formed in the heat resistant resin.

8. A method for manufacturing the electrical insulating sheet defined in claim 3, characterized in that, a heat resistant resin solution is prepared, then the heat resistant resin solution is impregnated into a woven or nonwoven fabric comprising polyester fiber and/or polyphenylene sulfide fiber so that the voids among the fibers of the woven or nonwoven fabric are filled with the heat resistant resin solution, a coagulating solution is contacted with the heat resistant resin solution in the woven or nonwoven fabric so that the solvent in the heat resistant resin solution is substituted with the coagulating solution whereupon continuous pores are formed in the heat resistant resin.

9. A method for manufacturing the electrical insulating sheet defined in claim 6, characterized in that, a heat resistant resin solution is prepared, then the heat resistant resin solution is impregnated into a woven or nonwoven fabric comprising polyester fiber and/or polyphenylene sulfide fiber so that the voids among the fibers of the woven or nonwoven fabric are filled with the heat resistant resin solution, a coagulating solution is contacted with the heat resistant resin solution in the woven or nonwoven fabric so that the solvent in the heat resistant resin solution is substituted with the coagulating solution whereupon continuous pores are formed in the heat resistant resin.
